(19) United States
(12) Patent Application Publication
(10) Pub. No.: US 2021/0064029 A1
(43) Pub. Date: Mar. 4, 2021

(54) AUTONOMOUS SAFE STOP FEATURE FOR A VEHICLE

(71) Applicant: Zenuity AB, Göteborg (SE)

(72) Inventor: Jane TARAKHOVSKY, Lake Orion, MI (US)

(21) Appl. No.: 16/550,489

(22) Filed: Aug. 26, 2019

(51) Int. Cl. G05D 1/00; G08G 1/0965

(52) U.S. Cl. CPC G05D 1/0088; G05D 2201/0213; G08G 1/0965; G05D 1/0055

(57) ABSTRACT

A system and method for autonomously bringing a vehicle to a safe stop at the request of a vehicle occupant in the event of an emergency situation, including: an actuation mechanism disposed in an occupant compartment of the vehicle, wherein the actuation mechanism is selectively actuatable by the vehicle occupant in the event of the emergency situation; a safe stop selection module operable for identifying a plurality of safe stop location candidates as the vehicle operates; a safe stop execution module operable for receiving an actuation signal generated by the actuation mechanism, selecting a safe stop location from the plurality of safe stop location candidates, and generating a corresponding vehicle control signal; and one or more vehicle control systems operable for receiving the vehicle control signal and causing the vehicle to come to a stop at the selected safe stop location in the event of the emergency situation.

### TECHNICAL FIELD

The present disclosure relates generally to the automotive and driver assist (DA) and autonomous driving (AD) fields. More particularly, the present disclosure relates to an autonomous safe stop feature for a vehicle.

### BACKGROUND

Unfortunately, there are occasions when the driver of a vehicle realizes that he or she is experiencing a health crisis and is not feeling well. Similarly, there are occasions when the driver of a vehicle realizes that his or her passenger, such as an elderly person or a child, is experiencing an emergency situation that needs immediate attention. The driver may continue to operate the vehicle in a compromised state until a safe stop location can be found, overestimating his or her control over the vehicle. This is not desirable as the driver may be significantly incapacitated or severely distracted, posing a danger to the driver, any passengers in the vehicle, and surrounding drivers and pedestrians. Examples of such health crises and emergency situations include, but are of course not limited to, a heart attack, a stroke, a seizure, a panic attack, an asthma attack, an allergic reaction, a drug or substance interaction, a choking event, vomiting, a labor pain, blurred vision, extreme drowsiness, suicidal behavior, and an extreme emotional disturbance.

In such cases, the significantly incapacitated or severely distracted driver must monitor road and traffic conditions, scan his or her surroundings for a safe stop location, and maneuver the vehicle to the safe stop location, before signaling or calling for assistance and dealing with the emergent crisis. With the emergence of various DA and AD systems, it would be preferable to have a vehicle essentially “take over” at the request of a driver (or automatically) in the event of a driver health crisis or passenger emergency situation and guide itself to a safe stop location on the shoulder of a road, at a nearby highway exit, or the like, and then signal or call for assistance. Similarly, it would be desirable to have a vehicle essentially “take over” at the request of an AD vehicle passenger (or automatically) in the event of an AD vehicle passenger health crisis or emergency situation and guide itself to a safe stop location on the shoulder of a road, at a nearby highway exit, or the like, and then signal or call for assistance. To date, no such feature exists that is simple enough to actuate and robust enough to ensure the safety of the driver, any passengers in the vehicle, and surrounding drivers and pedestrians.

### SUMMARY

The present disclosure provides such an autonomous safe stop feature for a vehicle. The safe stop feature includes a button or switch disposed within the vehicle that is readily accessible by the driver (and/or a passenger). When this button or switch is purposefully actuated, the vehicle “takes over” and guides itself to a safe stop location on the shoulder of a road, at a nearby highway exit, or the like, and then (or contemporaneously) signals or calls for assistance. Thus, upon purposeful actuation, the vehicle autonomously performs a safe stop maneuver, signals or calls for assistance, optionally initiates vehicle-to-infrastructure (V-I) communications to provide emergency information to one or more remote third parties, and optionally initiates vehicle-to-vehicle (V-V) communications to warn surrounding vehicles about what is occurring so that they may respond accordingly and/or potentially share safe stop location information.

The safe stop location selected by the vehicle is selected rapidly upon the purposeful actuation of the button or switch as the vehicle maintains an ongoing list of candidate safe stop locations at any given time. When the button or switch is purposefully actuated, the vehicle is able to select a safe stop location that is closest and/or most appropriate based on one or more criteria and an assessed emergency type, for example. This list of candidate safe stop locations may be assembled from relevant map data stored locally and/or remotely in the cloud, data acquired from other vehicles directly and/or through the cloud, and/or data acquired from one or more front/side/rear-facing and/or bird's-eye-view (BEV) vehicle exterior cameras, radar sensors, lidar sensors, and/or the like. These front/side/rear-facing and/or BEV vehicle exterior cameras, radar sensors, lidar sensors, and/or the like, along with appropriate vehicle processing and control systems, well known to persons of ordinary skill in the art, are also used to perform the ultimate safe stop maneuver, while ensuring the safety of the driver, any passengers in the vehicle, and surrounding drivers and pedestrians.

Although primarily purposeful actuation of the autonomous safe stop feature is contemplated by the present disclosure, this actuation may also be automatic based on an analysis of a vehicle interior camera image or images using a machine learning (ML)/artificial intelligence (AI) algorithm or the like, well known to persons of ordinary skill in the art. This vehicle interior camera may also be used to monitor and assess (and record) the condition of a driver or passenger on an ongoing basis once the button or switch is purposefully actuated, again using a ML/AI algorithm or the like, well known to persons of ordinary skill in the art, this emergency information being fed to the one or more remote third parties via the V-I communications link.

Further, the severity of the emergency event can be determined by the vehicle via the use of distinguishing button or switch actuations, the activation of a voice-command interface, or the opening of a voice communication channel after the purposeful actuation of the button or switch, with different emergency event severities triggering different safe stop location selections and safe stop maneuver executions. Still further, a driver can notify the vehicle in advance of potential emergency events that could be encountered based on known health conditions, for example, such that safe stop protocols and can be planned in advance to some extent.

In one example, the present disclosure provides a system for autonomously bringing a vehicle to a safe stop at the request of a vehicle occupant in the event of an emergency situation, the system and vehicle including: an actuation mechanism disposed in an occupant compartment of the vehicle, wherein the actuation mechanism is selectively actuatable by the vehicle occupant in the event of the emergency situation; a safe stop selection module operable for identifying a plurality of safe stop location candidates for the vehicle as the vehicle operates; a safe stop execution module operable for receiving an actuation signal generated by the actuation mechanism when the actuation mechanism is selectively actuated by the vehicle occupant, selecting a safe stop location for the vehicle from the plurality of safe stop location candidates for the vehicle responsive to receiving the actuation signal, and generating a corresponding vehicle control signal; and one or more vehicle control systems operable for receiving the vehicle control signal generated by the safe stop execution module and causing the vehicle to come to a stop at the selected safe stop location in the event of the emergency situation. The actuation mechanism includes one of a button, a switch, a virtual button, a virtual switch, a voice recognition device, and an interior camera. The safe stop execution module is further operable for receiving the actuation signal generated by the actuation mechanism when the actuation mechanism is selectively actuated by the vehicle occupant and actuating one or more exterior vehicle lights to alert other individuals and vehicles in proximity to the vehicle to the occurrence of the emergency situation. The safe stop execution module is further operable for receiving the actuation signal generated by the actuation mechanism when the actuation mechanism is selectively actuated by the vehicle occupant and initiating a vehicle-to-infrastructure protocol to alert other individuals and vehicles in proximity to the vehicle to the occurrence of the emergency situation. The safe stop execution module is further operable for receiving the actuation signal generated by the actuation mechanism when the actuation mechanism is selectively actuated by the vehicle occupant and initiating a vehicle-to-vehicle protocol to alert other vehicles in proximity to the vehicle to the occurrence of the emergency situation. The safe stop execution module is further operable for receiving the actuation signal generated by the actuation mechanism when the actuation mechanism is selectively actuated by the vehicle occupant and initiating an emergency call to alert emergency personnel to the occurrence of the emergency situation. The safe stop execution module is further operable for receiving the actuation signal generated by the actuation mechanism when the actuation mechanism is selectively actuated by the vehicle occupant and actuating one or more of a camera and a microphone to record events within the occupant compartment of the vehicle subsequent to the occurrence of the emergency situation. The actuation mechanism is enabled during one or more of a manual driving mode and an autonomous driving mode. The plurality of safe stop location candidates for the vehicle are identified utilizing data from one or more of an exterior camera, a radar sensor, and a lidar sensor coupled to the vehicle. The plurality of safe stop location candidates for the vehicle are also identified utilizing acquired map data.

In another example, the present disclosure provides a non-transitory computer readable medium stored in a memory as software and implemented by a processor for autonomously bringing a vehicle to a safe stop at the request of a vehicle occupant in the event of an emergency situation, the software executing the method steps including: identifying a plurality of safe stop location candidates for the vehicle as the vehicle operates; receiving an actuation signal from an actuation mechanism disposed in an occupant compartment of the vehicle, wherein the actuation mechanism is selectively actuatable by the vehicle occupant in the event of the emergency situation; selecting a safe stop location for the vehicle from the plurality of identified safe stop location candidates for the vehicle responsive to receiving the actuation signal; and generating a vehicle control signal for use by one or more vehicle control systems and causing the vehicle to come to a stop at the selected safe stop location in the event of the emergency situation. The actuation mechanism includes one of a button, a switch, a virtual button, a virtual switch, a voice recognition device, and an interior camera. The steps further include, responsive to receiving the actuation signal from the actuation mechanism, actuating one or more exterior vehicle lights to alert other individuals and vehicles in proximity to the vehicle to the occurrence of the emergency situation. The steps further include, responsive to receiving the actuation signal from the actuation mechanism, initiating a vehicle-to-infrastructure protocol to alert other individuals and vehicles in proximity to the vehicle to the occurrence of the emergency situation. The steps further include, responsive to receiving the actuation signal from the actuation mechanism, initiating a vehicle-to-vehicle protocol to alert other vehicles in proximity to the vehicle to the occurrence of the emergency situation. The steps further include, responsive to receiving the actuation signal from the actuation mechanism, initiating an emergency call to alert emergency personnel to the occurrence of the emergency situation. The steps further include, responsive to receiving the actuation signal from the actuation mechanism, actuating one or more of a camera and a microphone to record events within the occupant compartment of the vehicle subsequent to the occurrence of the emergency situation. The actuation mechanism is enabled during one or more of a manual driving mode and an autonomous driving mode. The plurality of safe stop location candidates for the vehicle are identified utilizing data from one or more of an exterior camera, a radar sensor, and a lidar sensor coupled to the vehicle. The plurality of safe stop location candidates for the vehicle are also identified utilizing acquired map data.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a schematic diagram illustrating one exemplary configuration of the autonomous safe stop system of the present disclosure, highlighting the broad environmental context;

FIG. 2 is a schematic diagram also illustrating one exemplary configuration of the autonomous safe stop system of the present disclosure, highlighting the more narrow local context; and

FIG. 3 is a flowchart illustrating one exemplary sequence of the autonomous safe stop method of the present disclosure.

### DETAILED DESCRIPTION OF EXAMPLES

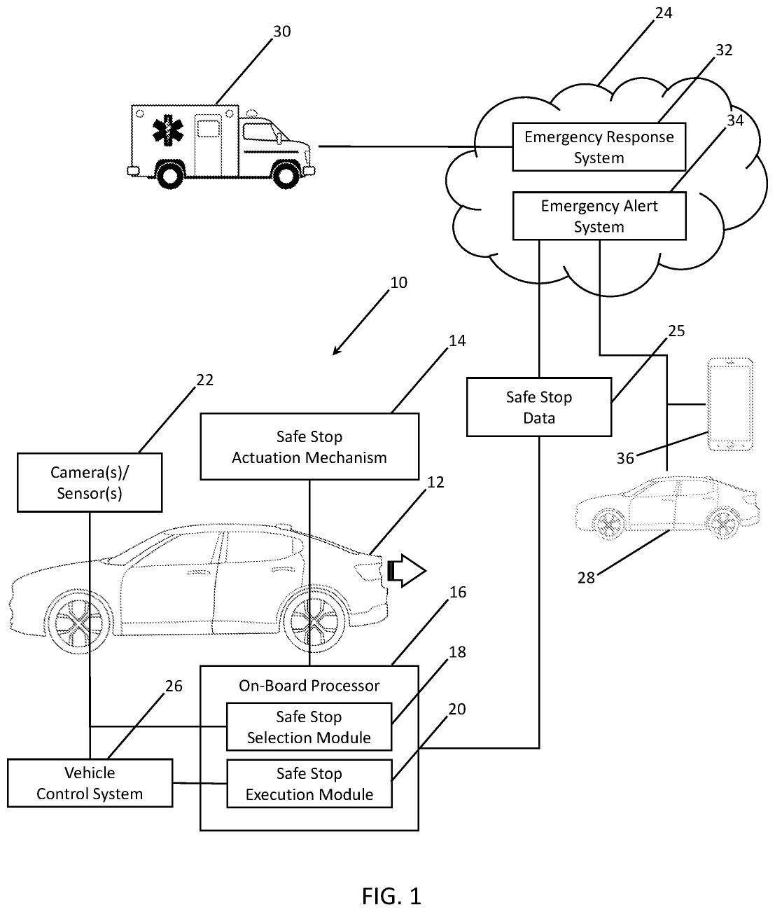

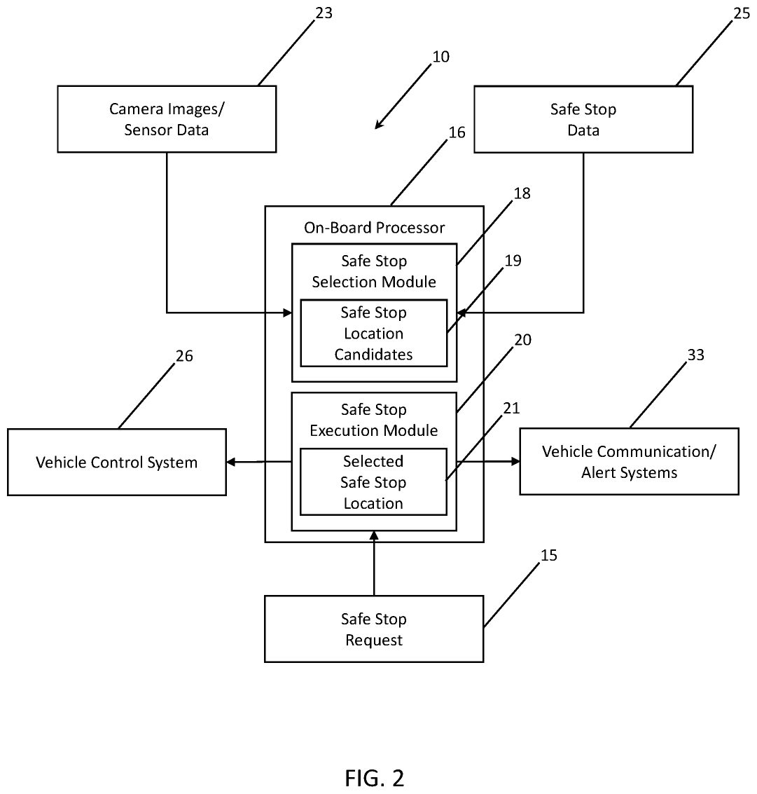

Referring now specifically to FIGS. 1 and 2, in one exemplary configuration, the autonomous safe stop system 10 of the present disclosure, which is implemented as a physical and software/firmware system in a vehicle 12, includes an actuation mechanism 14 disposed within the vehicle 12 that is readily accessible by the driver (and/or a passenger). For example, the actuation mechanism 14 may consist of a button or switch disposed on the dashboard or a console of the vehicle 12. Alternatively, the actuation mechanism 14 may consist of a virtual button or switch displayed on a display of the vehicle 12. Alternatively, the actuation mechanism 14 may consist of a voice recognition feature including a microphone and software/firmware that are collectively configured to receive and recognize an audible request or indication of an emergency event from the driver and/or a passenger. Alternatively, in a smart configuration, the actuation mechanism 14 may consist of a vehicle interior camera and software/firmware that are collectively configured to receive and recognize a visual request or indication of an emergency event from the driver and/or a passenger. The actuation mechanism 14 may have one or more activation safeties that act to ensure purposeful activation only in the event of an emergency event. Such activation safeties may include a physical button or switch guard, a virtual button or switch confirmation, a verbal or visual confirmation request, or the like. When the actuation mechanism 14 is purposefully actuated, a safe stop request 15 is generated and the vehicle 12 “takes over” and ultimately guides itself to a safe stop location on the shoulder of a road, at a nearby highway exit, or the like, and then (or contemporaneously) signals or calls for assistance. Thus, upon purposeful actuation of the safe stop system 10, the vehicle 12 autonomously performs a safe stop maneuver, signals or calls for assistance, optionally initiates V-I communications to provide emergency information to one or more remote third parties, and optionally initiates V-V communications to warn surrounding vehicles about what is occurring so that they may respond accordingly and/or potentially share safe stop location information, all of which is described in greater detail herein below.

The safe stop request 15 from the actuation mechanism 14 in the vehicle is received by an on-board processor 16 that includes a safe stop selection module 18 executing a safe stop selection algorithm and a safe stop execution module 20 executing a safe stop execution algorithm, both embodied in software/firmware and resident in a memory coupled to the on-board processor 16. The on-board processor 16 may include a cloud communications link and share processing duties collaboratively with one or more remote processors as well.

The safe stop selection module 18 and safe stop selection algorithm are operable for assembling and maintaining a list of safe stop location candidates 19 on a continual or nearly-continual basis as the vehicle 12 operates. This list of safe stop location candidates 19 is populated with potential safe stop locations that can be utilized by the vehicle 12 at any given time, if needed. Preferably, these safe stop locations are in reasonably close proximity to the vehicle 12 and include, for example, road shoulder locations, exit ramp locations, parking lot locations, emergency service locations, and the like where the vehicle 12 could potentially stop quickly and safely in the event of an emergency involving an incapacitated driver or passenger, given existing road and traffic conditions and the like. Here, a reasonably close proximity means that the vehicle 12 can be brought to a stop at the safe stop locations within a matter of seconds or minutes with the vehicle 12 travelling safely at or below the posted speed limits while maneuvering in an autonomous manner through traffic. The list of safe stop location candidates 19 is populated by the vehicle 12 scanning its surroundings using one or more vehicle exterior cameras, radar sensors, lidar sensors, and/or the like 22 on a continuous or nearly-continuous basis. As is well known to persons of ordinary skill in the art, such camera and sensor data 23 can be processed by a trained ML/AI algorithm to segment and identify various road conditions and objects. Here, the safe stop selection algorithm is used to identify open areas away from traffic, for example, or exit ramps, or emergency facilities, or anyplace where the vehicle 12 can safely stop in an emergency situation without endangering the driver, any passengers, and any third parties. This camera and sensor data 23 may be supplemented with predetermined safe stop location data 25 based on the global-positioning system (GPS) location of the vehicle 12 or the like at any given time and stored in the cloud 24, for example.

The safe stop execution module 20 and safe stop execution algorithm are operable for, upon receipt of the safe stop request 15 from the actuation mechanism 14, selecting a safe stop location 21 from the list of safe stop location candidates 19 based on one or more predetermined criteria. These predetermined criteria could include, for example, proximity to the vehicle 12, current observed road conditions, current observed traffic conditions, and type of emergency event (if determined). The safe stop execution algorithm is then operable for executing a safe stop maneuver and autonomously bringing the vehicle 12 to a safe stop at the selected safe stop location 21 using the autonomous vehicle control system(s) 26, as is done with any conventional AD maneuver. The autonomous vehicle control system(s) 26 may include steering control systems, accelerating/braking control systems, the aforementioned camera and sensor systems 22, and all related processing and control systems.

It should be noted that, although the safe stop selection module 18 and the safe stop execution module 20 are described as separate modules executing separate algorithms herein, they may share functionalities differently or simply represent different functionalities of a common module and/or algorithm, provided that they collectively maintain an ongoing list of safe stop location candidates 19 and, on demand, select a safe stop location 21 to be used from this list of safe stop location candidates 19 and autonomously execute a safe stop maneuver.

Thus, the safe stop location 21 selected by the vehicle 12 is selected rapidly upon the purposeful actuation of the button or switch as the vehicle 12 maintains an ongoing list of candidate safe stop locations 19 at any given time. When the button or switch is purposefully actuated, the vehicle 12 is able to select a safe stop location 21 that is closest and/or most appropriate based on one or more criteria and an assessed emergency type, for example. This list of candidate safe stop locations 19 may be assembled from relevant map data 25 stored locally and/or remotely in the cloud 24, data acquired from other vehicles 28 directly and/or through the cloud 24, and/or data 23 acquired from one or more front/side/rear-facing and/or BEV vehicle exterior cameras, radar sensors, lidar sensors, and/or the like 22. These front/side/rear-facing and/or BEV vehicle exterior cameras, radar sensors, lidar sensors, and/or the like 22, along with appropriate vehicle processing and control systems, well known to persons of ordinary skill in the art, are then used to perform the ultimate safe stop maneuver, while ensuring the safety of the driver, any passengers in the vehicle, and surrounding drivers and pedestrians.

Although primarily purposeful actuation of the autonomous safe stop feature is contemplated by the present disclosure, this actuation may also be automatic based on an analysis of a vehicle interior camera image or images using an ML/AI algorithm or the like, well known to persons of ordinary skill in the art. This vehicle interior camera may also be used to monitor and assess (and record) the condition of a driver or passenger on an ongoing basis once the button or switch is purposefully actuated, again using a ML/AI algorithm or the like, well known to persons of ordinary skill in the art, this emergency information being fed to one or more remote third parties (e.g., emergency responders 30) via the V-I communications link.

Thus, upon purposeful actuation of the autonomous safe stop feature, the safe stop execution module 20 optionally also activates the lights, flashers, and/or horn of the vehicle 12 to alert surrounding drivers and pedestrians to the occurrence of the emergency event and, hopefully, make the autonomous safe stop maneuver safer and allow third parties to assist the incapacitated or compromised driver or passenger. Likewise, the V-I and V-V communications links 33 of the vehicle 12 are used to communicate the emergency event to a remote emergency response system 32 and remote emergency alert system, that are used to mobilize emergency responders 30 and alert surrounding vehicles 28, respectively. The V-I interface may also be used to alert surrounding third parties via their mobile devices and the like 36.

Further, optionally, the severity of the emergency event can be determined by the vehicle 12 via the use of distinguishing button or switch actuations, the activation of a voice-command interface, or the opening of a voice communication channel after the purposeful actuation of the button or switch, with different emergency event severities possibly triggering different safe stop location selections and safe stop maneuver executions. For example, a diagnosed panic attack may cause the vehicle 12 to pull over to the side of the road or into a parking lot until the affected driver feels better, while a diagnosed heart attack or stroke may cause the vehicle 12 to pull over at a nearby hospital or meet an ambulance or the like at an intervening location, if reasonable, thereby expediting the rendering of emergency assistance. Still further, a driver can notify the vehicle 12 and on-board processor 16 in advance of potential emergency events that could be encountered based on known health conditions, for example, such that safe stop protocols and can be planned in advance to some extent. Thus, the safe stop execution module 20 can be made aware that a panic attack is possible or that the driver has been diagnosed with a heart condition, for example. Thus, more limited or more extreme precautions can be taken, possible with enhanced safe stop monitoring being performed.

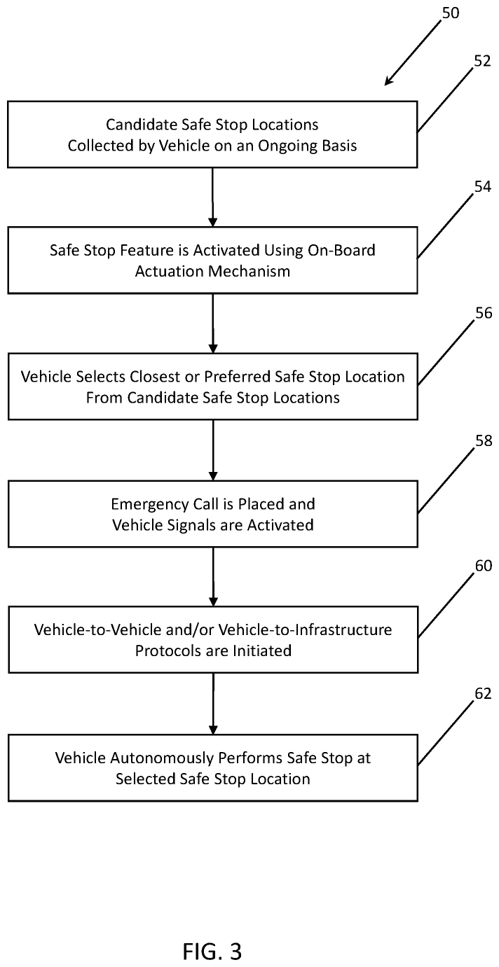

Referring now specifically to FIG. 3 (as well as FIGS. 1 and 2), in another exemplary configuration, the autonomous safe stop method 50 of the present disclosure, which is again implemented as a physical and software/firmware method in a vehicle 12, includes the activation of an actuation mechanism 14 disposed within the vehicle 12 that is readily accessible by the driver (and/or a passenger). (Step 54). For example, the actuation mechanism 14 may consist of a button or switch disposed on the dashboard or a console of the vehicle 12. Alternatively, the actuation mechanism 14 may consist of a virtual button or switch displayed on a display of the vehicle 12. Alternatively, the actuation mechanism 14 may consist of a voice recognition feature including a microphone and software/firmware that are collectively configured to receive and recognize an audible request or indication of an emergency event from the driver and/or a passenger. Alternatively, in a smart configuration, the actuation mechanism 14 may consist of a vehicle interior camera and software/firmware that are collectively configured to receive and recognize a visual request or indication of an emergency event from the driver and/or a passenger. The actuation mechanism 14 may have one or more activation safeties that act to ensure purposeful activation only in the event of an emergency event. Such activation safeties may include a physical button or switch guard, a virtual button or switch confirmation, a verbal or visual confirmation request, or the like. When the actuation mechanism 14 is purposefully actuated (step 54), a safe stop request 15 is generated and the vehicle 12 “takes over” and ultimately guides itself to a safe stop location on the shoulder of a road, at a nearby highway exit, or the like, and then (or contemporaneously) signals or calls for assistance (steps 56, 58, and 62). Thus, upon purposeful actuation of the safe stop system 10 (step 54), the vehicle 12 autonomously performs a safe stop maneuver (step 62), signals or calls for assistance (step 58), optionally initiates V-I communications to provide emergency information to one or more remote third parties, and optionally initiates V-V communications to warn surrounding vehicles about what is occurring so that they may respond accordingly and/or potentially share safe stop location information (step 60), all of which is described in greater detail herein below.

The safe stop request 15 from the actuation mechanism 14 in the vehicle is received by the on-board processor 16 that includes the safe stop selection module 18 executing the safe stop selection algorithm and the safe stop execution module 20 executing the safe stop execution algorithm, both embodied in software/firmware and resident in a memory coupled to the on-board processor 16. The on-board processor 16 may again include a cloud communications link and share processing duties collaboratively with one or more remote processors as well.

The safe stop selection module 18 and safe stop selection algorithm are operable for assembling and maintaining a list of safe stop location candidates 19 on a continual or nearly-continual basis as the vehicle 12 operates. (Step 52). This list of safe stop location candidates 19 is populated with potential safe stop locations that can be utilized by the vehicle 12 at any given time, if needed. Preferably, these safe stop locations are in reasonably close proximity to the vehicle 12 and include, for example, road shoulder locations, exit ramp locations, parking lot locations, emergency service locations, and the like where the vehicle 12 could potentially stop quickly and safely in the event of an emergency involving an incapacitated driver or passenger, given existing road and traffic conditions and the like. Here, a reasonably close proximity means that the vehicle 12 can be brought to a stop at the safe stop locations within a matter of seconds or minutes with the vehicle 12 travelling safely at or below the posted speed limits while maneuvering in an autonomous manner through traffic. The list of safe stop location candidates 19 is populated by the vehicle 12 scanning its surroundings using one or more vehicle exterior cameras, radar sensors, lidar sensors, and/or the like 22 on a continuous or nearly-continuous basis. As is well known to persons of ordinary skill in the art, such camera and sensor data 23 can be processed by a trained ML/AI algorithm or the like to segment and identify various road conditions and objects. Here, the safe stop selection algorithm is used to identify open areas away from traffic, for example, or exit ramps, or emergency facilities, or any place where the vehicle 12 can safely stop in an emergency situation without endangering the driver, any passengers, and any third parties. This camera and sensor data 23 may be supplemented with predetermined safe stop location data 25 based on the GPS location of the vehicle 12 or the like at any given time and stored in the cloud 24, for example.

The safe stop execution module 20 and safe stop execution algorithm are operable for, upon receipt of the safe stop request 15 from the actuation mechanism 14 (step 54), selecting a safe stop location 21 from the list of safe stop location candidates 19 based on one or more predetermined criteria. (Step 56). These predetermined criteria could include, for example, proximity to the vehicle 12, current observed road conditions, current observed traffic conditions, and type of emergency event (if determined). The safe stop execution algorithm is then operable for executing a safe stop maneuver and autonomously bringing the vehicle 12 to a safe stop at the selected safe stop location 21 using the autonomous vehicle control system(s) 26, as is done with any conventional AD maneuver. The autonomous vehicle control system(s) 26 may again include steering control systems, accelerating/braking control systems, the aforementioned camera and sensor systems 22, and all related processing and control systems.

It should again be noted that, although the safe stop selection module 18 and the safe stop execution module 20 are described as separate modules executing separate algorithms herein, they may share functionalities differently or simply represent different functionalities of a common module and/or algorithm, provided that they collectively maintain an ongoing list of safe stop location candidates 19 and, on demand, select a safe stop location 21 to be used from this list of safe stop location candidates 19 and autonomously execute a safe stop maneuver.

Thus, the safe stop location 21 selected by the vehicle 12 (step 56) is selected rapidly upon the purposeful actuation of the button or switch (step 54) as the vehicle 12 maintains an ongoing list of candidate safe stop locations 19 at any given time (step 52). When the button or switch is purposefully actuated (step 54), the vehicle 12 is able to select a safe stop location 21 that is closest and/or most appropriate based on one or more criteria and an assessed emergency type, for example (step 56). This list of candidate safe stop locations 19 may be assembled from relevant map data 25 stored locally and/or remotely in the cloud 24, data acquired from other vehicles 28 directly and/or through the cloud 24, and/or data 23 acquired from one or more front/side/rear-facing and/or BEV vehicle exterior cameras, radar sensors, lidar sensors, and/or the like 22. These front/side/rear-facing and/or BEV vehicle exterior cameras, radar sensors, lidar sensors, and/or the like 22, along with appropriate vehicle processing and control systems, well known to persons of ordinary skill in the art, are then used to perform the ultimate safe stop maneuver, while ensuring the safety of the driver, any passengers in the vehicle, and surrounding drivers and pedestrians.

Again, although primarily purposeful actuation of the autonomous safe stop feature is contemplated by the present disclosure, this actuation may also be automatic based on the analysis of a vehicle interior camera image or images using an ML/AI algorithm or the like, well known to persons of ordinary skill in the art. This vehicle interior camera may also be used to monitor and assess (and record) the condition of a driver or passenger on an ongoing basis once the button or switch is purposefully actuated, again using a ML/AI algorithm or the like, well known to persons of ordinary skill in the art, this emergency information being fed to one or more remote third parties (e.g., emergency responders 30) via the V-I communications link.

Thus, upon purposeful actuation of the autonomous safe stop feature (step 54), the safe stop execution module 20 optionally also activates the lights, flashers, and/or horn of the vehicle 12 (step 58) to alert surrounding drivers and pedestrians to the occurrence of the emergency event and, hopefully, make the autonomous safe stop maneuver safer and allow third parties to assist the incapacitated or compromised driver or passenger. Likewise, the V-I and V-V communications links 33 of the vehicle 12 are used to communicate the emergency event to a remote emergency response system 32 and remote emergency alert system (step 60), that are used to mobilize emergency responders 30 and alert surrounding vehicles 28, respectively. The V-I interface may also be used to alert surrounding third parties via their mobile devices and the like 36.

Further, optionally, the severity of the emergency event can be determined by the vehicle 12 via the use of distinguishing button or switch actuations, the activation of a voice-command interface, or the opening of a voice communication channel after the purposeful actuation of the button or switch, with different emergency event severities possibly triggering different safe stop location selections and safe stop maneuver executions. For example, a diagnosed panic attack may cause the vehicle 12 to pull over to the side of the road or into a parking lot until the affected driver feels better, while a diagnosed heart attack or stroke may cause the vehicle 12 to pull over at a nearby hospital, if reasonable. Still further, a driver can notify the vehicle 12 and on-board processor 16 in advance of potential emergency events that could be encountered based on known health conditions, for example, such that safe stop protocols and can be planned in advance to some extent. Thus, the safe stop execution module 20 can be made aware that a panic attack is possible or that the driver has been diagnosed with a heart condition, for example. Thus, more limited or more extreme precautions can be taken, possible with enhanced safe stop monitoring being performed.

Still further, once the safe stop function is enabled, relevant emergency situation information can be displayed within the vehicle 12 in order to assist the driver or a passenger, especially if the type of emergency event is established. This functionality can utilize a human-machine interface (HMI). For example, if someone is having a panic attack, the HMI could display directions accompanied by pictures with the option of being voice activated and/or with the option of displaying a video. Information could be provided to reassure the person, to speak to the person in positive, supportive terms, such as “you will be okay, this will pass in a minute”, to encourage person to breathe calmly and slowly, in and out through their nose and out of their mouth, and/or, finally, to drink small sips of water if available. If somebody is having an asthma attack without an inhaler, then the HMI could offer the following suggestions: sit upright, take long, deep breaths, stay calm, and take a hot caffeinated beverage, such as tea or coffee, if available. In the case of heart attack, the directions provided on the screen could firstly have a person sit down and loosen any tight clothing (post-safe stop). Next, pain and medications could be inquired about and relevant directions provided. If the person is unconscious and unresponsive, then cardio-pulmonary resuscitation (CPR) directions with pictures and video could be displayed on the screen. During a medical emergency, every minute counts and these additional features could be very beneficial. These displayed interactions could be extended to children, pets, etc. as well.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) a tangible computer-readable storage medium that is non-transitory or (2) a communication medium, such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include random-access memory (RAM), read-only memory (ROM), electrically erasable-programmable read-only memory (EEPROM), compact disc read-only memory (CD-ROM) or other optical disc storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared (IR), radio frequency (RF), and microwave, then the coaxial cable, fiber optic cable, twisted pair, DSL, or wireless technologies, such as IR, RF, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), complex programmable logic devices (CPLDs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Thus, the present disclosure provides an autonomous safe stop feature for a vehicle. The safe stop feature includes a button or switch disposed within the vehicle that is readily accessible by the driver (and/or a passenger). When this button or switch is purposefully actuated, the vehicle “takes over” and guides itself to a safe stop location on the shoulder of a road, at a nearby highway exit, or the like, and then (or contemporaneously) signals or calls for assistance. Thus, upon purposeful actuation, the vehicle autonomously performs a safe stop maneuver, signals or calls for assistance, optionally initiates V-I communications to provide emergency information to one or more remote third parties, and optionally initiates V-V communications to warn surrounding vehicles about what is occurring so that they may respond accordingly and/or potentially share safe stop location information.

The safe stop location selected by the vehicle is selected rapidly upon the purposeful actuation of the button or switch as the vehicle maintains an ongoing list of candidate safe stop locations at any given time. When the button or switch is purposefully actuated, the vehicle is able to select a safe stop location that is closest and/or most appropriate based on one or more criteria and an assessed emergency type, for example. This list of candidate safe stop locations may be assembled from relevant map data stored locally and/or remotely in the cloud, data acquired from other vehicles directly and/or through the cloud, and/or data acquired from one or more front/side/rear-facing and/or BEV vehicle exterior cameras, radar sensors, lidar sensors, and/or the like. These front/side/rear-facing and/or BEV vehicle exterior cameras, radar sensors, lidar sensors, and/or the like, along with appropriate vehicle processing and control systems, well known to persons of ordinary skill in the art, are also used to perform the ultimate safe stop maneuver, while ensuring the safety of the driver, any passengers in the vehicle, and surrounding drivers and pedestrians.

Although primarily purposeful actuation of the autonomous safe stop feature is contemplated by the present disclosure, this actuation may also be automatic based on the analysis of a vehicle interior camera image or images using a ML/AI algorithm or the like, well known to persons of ordinary skill in the art. This vehicle interior camera may also be used to monitor and assess (and record) the condition of a driver or passenger on an ongoing basis once the button or switch is purposefully actuated, again using a ML/AI algorithm or the like, well known to persons of ordinary skill in the art, this emergency information being fed to the one or more remote third parties via the V-I communications link.

Further, the severity of the emergency event can be determined by the vehicle via the use of distinguishing button or switch actuations, the activation of a voice-command interface, or the opening of a voice communication channel after the purposeful actuation of the button or switch, with different emergency event severities triggering different safe stop location selections and safe stop maneuver executions. Still further, a driver can notify the vehicle in advance of potential emergency events that could be encountered based on known health conditions, for example, such that safe stop protocols and can be planned in advance to some extent.

Although the present disclosure is illustrated and described herein with reference to preferred embodiments and specific examples thereof, it will be readily apparent to persons of ordinary skill in the art that other embodiments and examples may perform similar functions and/or achieve like results. All such equivalent embodiments and examples are within the spirit and scope of the present invention, are contemplated thereby, and are intended to be covered by the following non-limiting claims for all purposes.

What is claimed is:

1. A system for autonomously bringing a vehicle to a safe stop at the request of a vehicle occupant in the event of an emergency situation, the system comprising:
an actuation mechanism disposed in an occupant compartment of the vehicle, wherein the actuation mechanism is selectively actuatable by the vehicle occupant in the event of the emergency situation;
a safe stop selection module operable for identifying a plurality of safe stop location candidates for the vehicle on an ongoing basis as the vehicle operates;
a safe stop execution module operable for receiving an actuation signal generated by the actuation mechanism when the actuation mechanism is selectively actuated by the vehicle occupant, selecting a safe stop location for the vehicle from the plurality of safe stop location candidates for the vehicle responsive to receiving the actuation signal, and generating a corresponding vehicle control signal; and
one or more vehicle control systems operable for receiving the vehicle control signal generated by the safe stop execution module and causing the vehicle to come to a stop at the selected safe stop location in the event of the emergency situation.

2. The system of claim 1, wherein the actuation mechanism comprises one of a button, a switch, a virtual button, a virtual switch, a voice recognition device, a gesture recognition device, and an interior camera.

3. The system of claim 1, wherein the safe stop execution module is further operable for receiving the actuation signal generated by the actuation mechanism when the actuation mechanism is selectively actuated by the vehicle occupant and actuating one or more exterior vehicle lights to alert other individuals and vehicles in proximity to the vehicle to the occurrence of the emergency situation.

4. The system of claim 1, wherein the safe stop execution module is further operable for receiving the actuation signal generated by the actuation mechanism when the actuation mechanism is selectively actuated by the vehicle occupant and initiating a vehicle-to-infrastructure or vehicle-to-device protocol to alert other individuals and vehicles in proximity to the vehicle to the occurrence of the emergency situation.

5. The system of claim 1, wherein the safe stop execution module is further operable for receiving the actuation signal generated by the actuation mechanism when the actuation mechanism is selectively actuated by the vehicle occupant and initiating a vehicle-to-vehicle protocol to alert other vehicles in proximity to the vehicle to the occurrence of the emergency situation.

6. The system of claim 1, wherein the safe stop execution module is further operable for receiving the actuation signal generated by the actuation mechanism when the actuation mechanism is selectively actuated by the vehicle occupant and directly or indirectly initiating an emergency call to alert emergency personnel to the occurrence of the emergency situation.

7. The system of claim 1, wherein the safe stop execution module is further operable for receiving the actuation signal generated by the actuation mechanism when the actuation mechanism is selectively actuated by the vehicle occupant and actuating one or more of a camera and a microphone to record events within the occupant compartment of the vehicle for contemporaneous or later use subsequent to the occurrence of the emergency situation.

8. The system of claim 1, wherein the actuation mechanism is enabled during one or more of a manual driving mode and an autonomous driving mode.

9. The system of claim 1, wherein the plurality of safe stop location candidates for the vehicle are identified utilizing data from one or more of an exterior camera, a radar sensor, and a lidar sensor coupled to the vehicle.

10. The system of claim 1, wherein the plurality of safe stop location candidates for the vehicle are identified utilizing acquired map data.

11. A non-transitory computer readable medium stored in a memory as software and implemented by a processor for autonomously bringing a vehicle to a safe stop at the request of a vehicle occupant in the event of an emergency situation, the software executing the steps comprising:
identifying a plurality of safe stop location candidates for the vehicle on an ongoing basis as the vehicle operates;
receiving an actuation signal from an actuation mechanism disposed in an occupant compartment of the vehicle, wherein the actuation mechanism is selectively actuatable by the vehicle occupant in the event of the emergency situation;
selecting a safe stop location for the vehicle from the plurality of identified safe stop location candidates for the vehicle responsive to receiving the actuation signal; and
generating a vehicle control signal for use by one or more vehicle control systems and causing the vehicle to come to a stop at the selected safe stop location in the event of the emergency situation.

12. The non-transitory computer-readable medium of claim 11, wherein the actuation mechanism comprises one of a button, a switch, a virtual button, a virtual switch, a voice recognition device, a gesture recognition device, and an interior camera.

13. The non-transitory computer-readable medium of claim 11, wherein the steps further comprise, responsive to receiving the actuation signal from the actuation mechanism, actuating one or more exterior vehicle lights to alert other individuals and vehicles in proximity to the vehicle to the occurrence of the emergency situation.

14. The non-transitory computer-readable medium of claim 11, wherein the steps further comprise, responsive to receiving the actuation signal from the actuation mechanism, initiating a vehicle-to-infrastructure or vehicle-to-device protocol to alert other individuals and vehicles in proximity to the vehicle to the occurrence of the emergency situation.

15. The non-transitory computer-readable medium of claim 11, wherein the steps further comprise, responsive to receiving the actuation signal from the actuation mechanism, initiating a vehicle-to-vehicle protocol to alert other vehicles in proximity to the vehicle to the occurrence of the emergency situation.

16. The non-transitory computer-readable medium of claim 11, wherein the steps further comprise, responsive to receiving the actuation signal from the actuation mechanism, directly or indirectly initiating an emergency call to alert emergency personnel to the occurrence of the emergency situation.

17. The non-transitory computer-readable medium of claim 11, wherein the steps further comprise, responsive to receiving the actuation signal from the actuation mechanism, actuating one or more of a camera and a microphone to record events within the occupant compartment of the vehicle for contemporaneous or later use subsequent to the occurrence of the emergency situation.

18. The non-transitory computer-readable medium of claim 11, wherein the actuation mechanism is enabled during one or more of a manual driving mode and an autonomous driving mode.

19. The non-transitory computer-readable medium of claim 11, wherein the plurality of safe stop location candidates for the vehicle are identified utilizing data from one or more of an exterior camera, a radar sensor, and a lidar sensor coupled to the vehicle.

20. The non-transitory computer-readable medium of claim 11, wherein the plurality of safe stop location candidates for the vehicle are identified utilizing acquired map data.
